(19) United States
(12) Patent Application Publication
(10) Pub. No.: US 2026/0106902 A1
(43) Pub. Date: Apr. 16, 2026

(54) METHODS FOR SECURE CONFIGURATION AND PROVISIONING OF USER EQUIPMENT POLICY

(71) Applicant: INTERDIGITAL PATENT HOLDINGS, INC., Wilmington, DE (US)

(72) Inventors: Samir FERDI, Kirkland (CA); Michael STARSINIC, Newtown, PA (US); Anuj SETHI, Ottawa (CA); Zhibi WANG, Woodbridge, IL (US); Ulises OLVERA-HERNANDEZ, Saint-Lazare (CA); Alec BRUSILOVSKY, Downingtown, PA (US); Achref METHENNI, Montreal (CA)

(73) Assignee: INTERDIGITAL PATENT HOLDINGS, INC., Wilmington, DE (US)

(21) Appl. No.: 19/112,356

(22) PCT Filed: Sep. 14, 2023
(86) PCT No.: PCT/US2023/032730

§ 371 Date: Mar. 17, 2025

Related U.S. Application Data
(60) Provisional application No. 63/410,539, filed on Sep. 27, 2022.

(51) Int. Cl. H04L 9/40

(52) U.S. Cl. CPC H04L 63/20; H04L 63/123

(57) ABSTRACT

A method performed by a wireless transmit/receive unit (WTRU) for secure policy provisioning includes receiving a network message including new policy information, a first policy message authentication code (MAC) generated by a network (P-MAC-N), and a policy protection counter (PPC). The WTRU generates a second policy MAC using a security key shared with the network, the new policy information, and the PPC, and verifies the integrity of the network message by determining that the P-MAC-N matches the second policy MAC. After the verification, the WTRU updates the previous policy information of the WTRU using the new policy information based on the match of the P-MAC-N and the second policy MAC.

### CROSS REFERENCE TO RELATED APPLICATIONS

This application claims the benefit of U.S. provisional patent application No. 63/410,539 filed 27 Sep. 2022 which is incorporated by reference herein in its entirety.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a signal diagram depicting an example method according to aspects of the disclosure;

FIG. 3 depicts an example method performed by a wireless transmit/receive unit (WTRU) according to aspects of the disclosure; and

FIG. 4 depicts an example method performed by a network node according to aspects of the disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

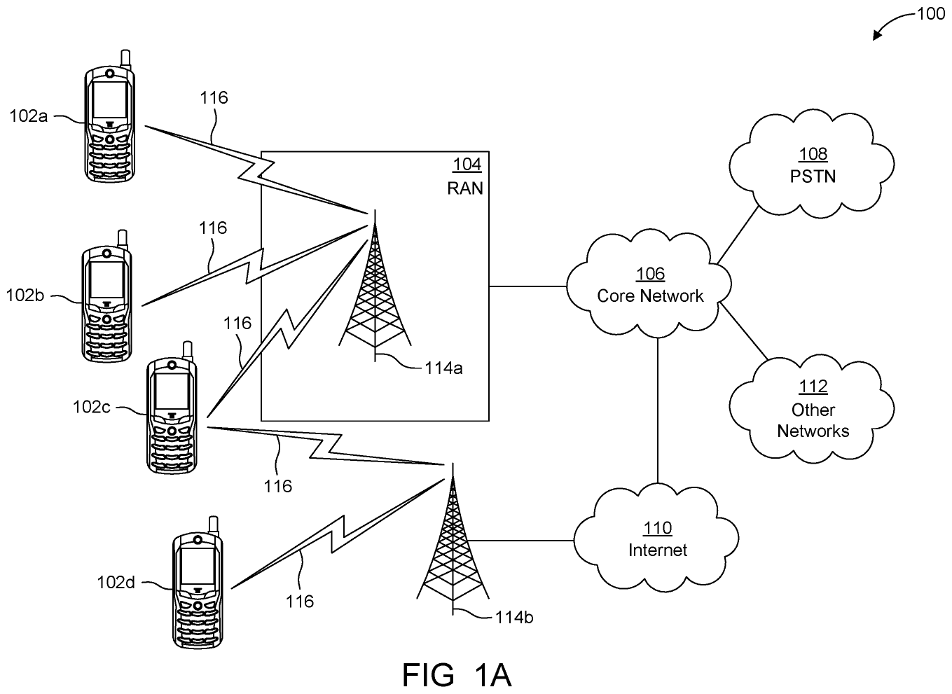

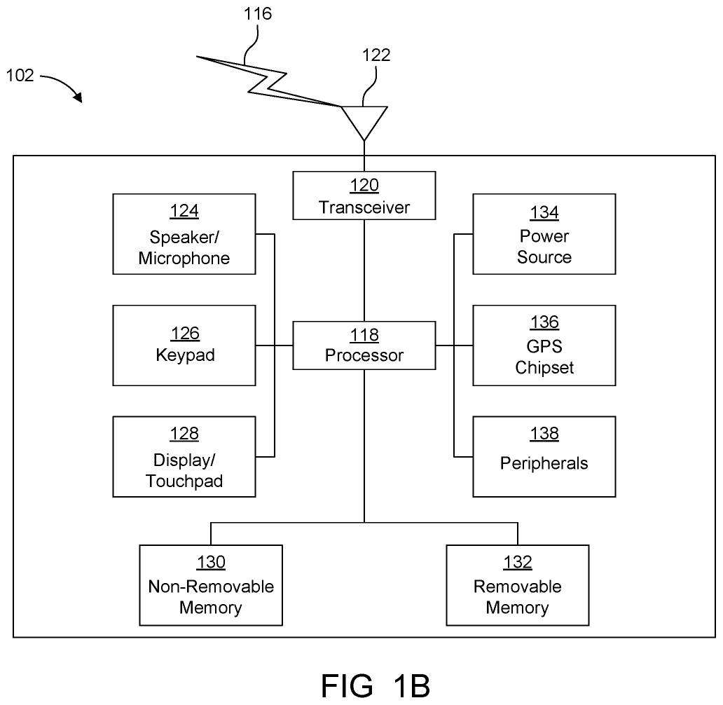

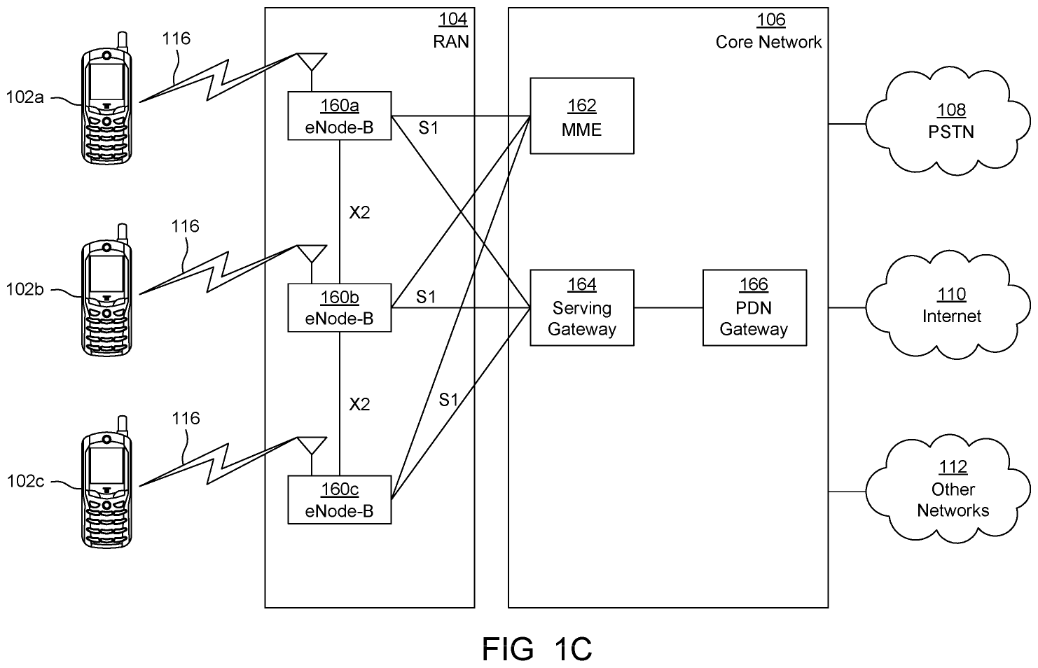

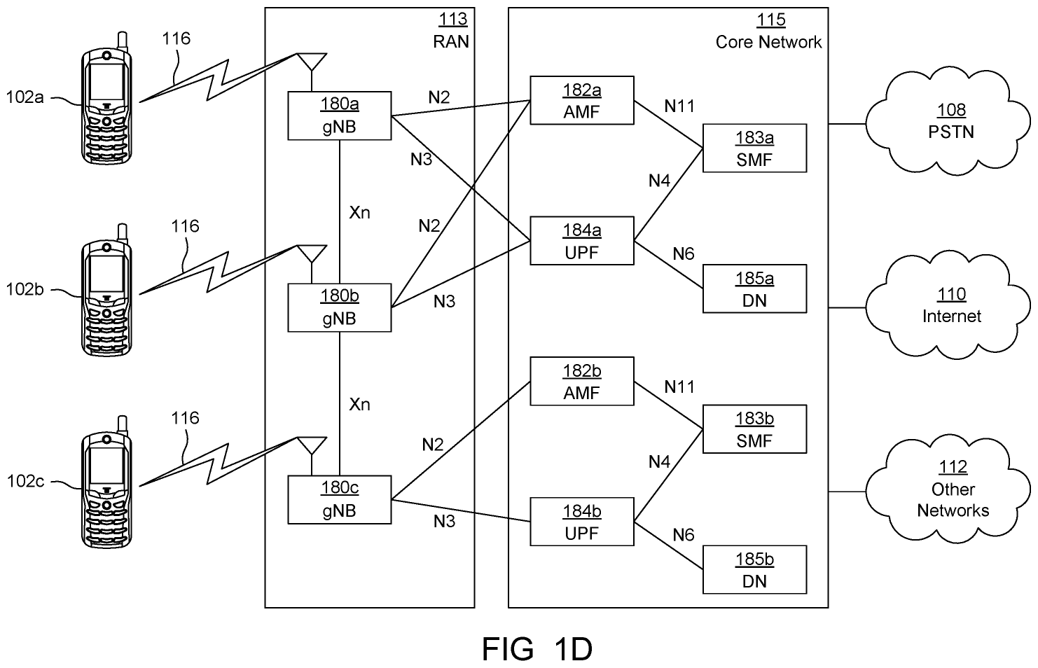

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11 af and 802.11 ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3 access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating user equipment (UE) IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185bthrough the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

### BACKGROUND

### UE Route Selection Policy (URSP) Provisioning Up To Release 17 (Rel-17) of 3GPP

At the time of this disclosure, the following is a current view of the Rel-17 framework for URSP. The current policy control framework, including UE Route Selection Policy (URSP) provisioning in particular, are described in 3GPP TS 23.503 v17.5.0. URSP is a policy used by the UE to determine how to route outgoing traffic. For example, traffic can be routed to an established PDU Session or can trigger the establishment of a new PDU Session. According to existing UE Route Selection Policy (URSP) configuration and provisioning procedure the UE only accepts URSP rules from home public land mobile network (HPLMN). This can be done by pre-configuration (e.g., by the operator) or communicated via signaling from the policy control function (PCF) of the HPLMN, as defined in 3GPP TS 23.503 v17.5.0. The URSP rules that are communicated via signaling take precedence over the pre-configured ones if both are present. In the case of a roaming UE, the home PCF (H-PCF) transfers the URSP Rules to the UE via visiting PCF (V-PCF). The URSP along with other types of policies (e.g., vehicle to everything policy (V2XP), access network discovery selection policy (ANDSP) which includes WLAN Selection Policy (WLANSP) rules, proximity services policy (ProseP)) are part of the UE policy information. UE policy information may be divided by the PCF into different Policy Sections with self-contained content (e.g., no splitting of a URSP Rules across Policy Sections) to allow proper delivery to the UE. The PCF decides to split up the UE policy info into multiple Policy Sections based on the above self-contained requirement and on a size limit known to PCF (e.g., to allow delivery over non-access stratum (NAS) transport). Each Policy Section is identified by a Policy Section Identifier (PSI).

### WLAN Selection Policy (WLANSP) Provisioning Up to Rel-17

A UE may receive Access Network Discovery and Selection Policies (ANDSP). An ANDSP may contain one or more WLAN Selection Policy (WLANSP) rules defined in clause 4.8.2.1.6 of TS 23.402 3GPP TS 23.402 v17.0.0.

The WLANSP(s) are a set of rules that are used by the UE to select and reselect WLAN access networks to connect to. The rules are provided to the UE with priority information where each rule is assigned its priority. The UE evaluates the rules in priority order and selects a WLAN access network that matches/fulfils the requirements of the highest priority rule.

The rules can also contain information about when they should be considered valid (e.g., time and location validity conditions).

ANDSP Policies are received by the UE via NAS messaging. For example, ANDSP policies are received in policy sections that are received in in the UE Configuration Update procedure. The UE configuration Update procedure is defined in 3GPP TS 23.502 v17.5.0.

WLANSP Rules can come from the HPLMN and/or the visiting PLMN (VPLMN). The Rule ID tells the UE if the WLANSP Rule came from the HPLMN or VPLMN. The UE determines which rules take priority based on whether or not the UE is roaming. When the UE is roaming, the UE will prioritize the WLANSP Rules of the visited network. In other words, when the UE is roaming, the UE will make decisions based on the WLANSP rules of the home network only if no network is found based on the WLANSP Rules of the visited network. This prioritization procedure is described in section 6.6.1.3 of 3GPP TS 23.503 v17.5.0.

### UE Policy Enhancements in Rel-18

Systems Aspects Working Group 2 (SA2) is studying potential enhancements to the URSP rule provisioning and updating procedures in the roaming scenario (see 3GPP TR 23.700-85 v1.0.0), while keeping backward compatibility with existing HPLMN based policy control as described above.

At this time of this disclosure, the following principles for enhancements are agreed. Adding support for PLMN specific URSP Rules where a HPLM ID or VPLMN ID is provided along with the URSP to identify the PLMN where the URSP is applicable. The H-PCF generates and provides VPLMN specific URSP Rules to the UE

### Secure Parameters Provisioning

3GPP has defined security mechanisms for the transfer of parameters from the home network e.g., VPLMN list info for Steering of Roaming (SoR) or UE parameters update (UPU) (see 3GPP TS 33.501 v17.6.0).

For both, SoR and UPU procedures, the unified data management (UDM) invokes a security protection service from the authentication server function (AUSF) to provide end to end integrity protection of information transmitted to the UE. In both cases the protection information is sent by the UDM to be relayed by serving AMF in the VPLMN, to the UE. In the case the of SoR, the security mechanism may be triggered when the UE registers with the VPLMN or after that. In the case of UPU, the security mechanism may be triggered any time after the UE has been successfully registered in the 5GS.

### Issues Concerning UE Policy Provisioning

Up to Rel-17 the URSP rules are generated and transferred by the H-PCF to the roaming UE via the V-PCF based on a trust relationship between the HPLMN and VPLMN. With that approach there is a potential risk of URSP Rules being modified by the VPLMN (V-PCF), inadvertently or maliciously. For example, there is currently no mechanism for the UE to verify whether the URSP Rules associated with the HPLMN (e.g., with HPLMN ID) have been tampered with by the VPLMN.

A similar problem exists when WLANSP Rules are transferred from the H-PCF to the V-PCF. There is a potential risk of WLANSP Rules being modified by the VPLMN (V-PCF), inadvertently or maliciously. For example, the V-PCF may modify WLANSP Rules that were generated by the home network. Later, when the UE is being served by the home network, the UE may apply WLANSP Rules that were modified by the visited network that was previously serving the UE.

One issue is how to enable the 5GS to enforce the principle of HPLMN based policy control, in particular when considering the enhancements for UE Policy provisioning in roaming scenarios (e.g., support for PLMN specific URSP rules).

### PROPOSED SOLUTIONS

### UE Policy Information Provisioning Security Mechanism

This solution describes how to support secure UE policy information provisioning to a UE (e.g., while roaming) by an H-PCF during a UE Configuration Update procedure for transparent policy delivery. The UE policy information may include URSP which includes various PLMN specific USRP Rules. For example, a set of USRP Rules may be associated with a HPLMN ID, while another set of rules may be associated with a VPLMN ID.

The procedures that are described in this document show how UE policy information, which may contain URSP Rule(s), may be securely sent from a home network function to a UE. These procedures may also be used to securely send UE policy information that contain other types of policies (e.g., V2XP, ANDSP, (WLANSP), ProseP) to the UE.

### Behavior on the UE (e.g., Roaming UE)

The behavior of a UE in, for example, a roaming environment may be as follows:
1. The UE receives a NAS command message (e.g., using NAS transport) including UE policy information, a network generated Policy Message Authentication Code (P-MAC-N) and a Policy Protection Counter (PPC). The NAS message may include a request to send a secure acknowledge (ack) of the successful reception of the UE policy information. The MAC is calculated by the network (AUSF) using a shared key with the UE (e.g., key AUSF (KAUSF)), the UE policy information, and PPC which enables the UE and network functions of the home network to verify that the UE policy information has not been tampered with. The P-MAC-N, PPC, and an indication that a secure ack is requested may be encoded in an information element along with the policy information. They may be encoded in this manner and may be separate from the policy information itself so that these information elements can be received and ignored by legacy UEs that do not understand this information. Encoding the P-MAC-N, PPC, and an indication that a secure ack is requested in this manner also allows the H-PCF to request the UE to send a UE generated policy message authentication code (P-MAC-UE) to acknowledge policy information that was sent to the UE in an earlier UE Configuration Update procedure. The UE may receive UE Policy that is split and transferred as several UE Policy information parts (e.g., including each one or more Policy Sections) across multiple messages. The UE re-assembles the UE Policy information using all the received UE Policy information parts before verifying the UE Policy security as described in next step.
2. The UE calculates a MAC using the shared key with the network (e.g., KAUSF), UE policy information and PPC the same way as the network. The UE verifies that the calculated MAC matches the received P-MAC-N. If the verification is successful, the UE updates its policy with the received policy information. If a secure ack was requested by the network, the UE calculates a MAC (P-MAC-UE) using the shared key, an indication of policy update (e.g., success/failure) and the PPC. The UE discards the message if the MAC verification fails. In one embodiment, with unsuccessful verification, the UE may not send an ack. With an unsuccessful verification, there was either an attempt to tamper the with the new policy or a resend/replay of it to the UE. Either way the UE should just ignore the newly received policy. In one embodiment, if H-PCF did in fact send the new (updated) policy, the H-PCF will eventually detect the problem (e.g., using existing timeout mechanisms).
3. The UE sends a NAS response message including the result (e.g., success/failure) of the UE Policy processing along with the P-MAC-UE.

The UE may enforce the policy protection verification based on operator provided UE (pre)configuration (e.g., stored on ME or USIM). For example, such configuration may indicate the types of policy (e.g., URSP, WLANSP) for which to enforce the secure policy provisioning verification. The UE verifies the type of policy received and whether a security protection is expected with it based on the configuration. The configuration may indicate to enforce secure policy provisioning verification on a per VPLMN basis. For example, the HPLMN may decide to enforce secure policy provisioning with some roaming partners but not others based on roaming agreements. The UE verifies the serving VPLMN ID and decide whether security protection is required based on the configuration.

Behavior on the H-pcf:

The behavior of the H-PCF may include the following:
1. The H-PCF decides to update UE policy (e.g., during initial registration, change of UE location, change of slice subscription etc.).
2. H-PCF obtains parameters from V-PCF (or based on V-AF information) and constructs and stores UE Policy information e.g., including HPLMN and VPLMN specific URSP rules.
3. The H-PCF sends a request for Policy information protection to the UDM including the UE Policy information and indication for UE ack requested.
4. The H-PCF receives a response from UDM including P-MAC-N, PPC and an expected UE generated MAC (X-P-MAC-UE). The H-PCF stores the X-P-MAC-UE with the policy information. H-PCF may receive from UDM a pair of X-P-MAC-UE, each with an indication of respectively, successful and unsuccessful policy update indications.
5. The H-PCF sends a request message to the AMF via V-PCF to transfer the UE Policy information along with P-MAC-N, Counter and request for secure ack from UE.
6. The H-PCF receives a response message from the AMF via V-PCF including UE policy update result and P-MAC-UE originated at the UE.
7. The H-PCF compares received P-MAC-UE with the stored X-P-MAC-UE. If the P-MAC-UE verification is successful, the H-PCF further process the UE policy update result otherwise if considers as the update as failed.

In the above, the V-PCF may decide to split the Policy information into smaller UE Policy information parts (e.g., UE Policy information fragments) based on self-contained content and size limit requirements as per the above section entitled URSP Provisioning up to Rel-17. In one example, a UE Policy information fragment may comprise one or more Policy Sections. The following actions may be performed: the H-PCF requests protection for the complete UE Policy information from UDM/AUSF regardless of the size of the resulting UE Policy information and sends UE Policy information, P-MAC-N, PPC, and request for ACK to V-PCF. The V-PCF proceeds with the splitting of the UE Policy information into fragments that are sent individually to the UE via the AMF. The V-PCF may provide the UE with the information to assist in the reassembly of the complete UE Policy (e.g., include the total number of expected UE Policy fragments, for each sent fragment its index/position in the list of fragments). The UE reconstructs the complete UE Policy information based on received fragments and associated reassembly assistance information. The UE performs the security check on the resulting reassembled UE Policy information as described above.

In another example, the H-PCF may perform UE Policy information fragmentation/splitting. The H-PCF may obtain from V-PCF a transport size limit to split the policy information according to that a particular size requirement i.e., so that any Policy information fragment sent to the UE can fit into a single Namf_Communication_N1N2MessageTransfer call to AMF. In addition, or alternatively, the H-PCF may request the protection of UE policy information for certain types of policy (e.g., URSP, WLANSP) but not for other (e.g., V2XP, ProseP). The H-PCF may split UE Policy information in fragments/parts that needs to be protected and parts to do not need to be protected accordingly. The UE may enforce integrity check on the received UE policy information according to the applicable types of policy (e.g., based on a UE configuration, described above). In such scenario the H-PCF proceeds similarly to above for the secure provisioning of UE policy for each individual UE Policy information fragment at a time. In that case the H-PCF handles each UE Policy info fragment each with its own P-MAC-N, PPC, P-MAC-UE to be sent to the UE individually.

Existing UEs do not support the procedure that is described above, therefore the H-PCF cannot expect to receive a response that includes the P-MAC-UE from such a UE. In order to allow the H-PCF to detect a situation where the AMF or V-PCF has not provided the P-MAC-UE from the UE in the Namf_Communication_N1MessageNotify message, the UDM may indicate to the H-PCF that a response with P-MAC-UE should be expected from the UE. The UDM may determine to send this indication to the PCF based on pre-configuration (e.g., see example of such pre-configuration above) and/or based on a support indication that was received from the UE in the 5 GS mobility management (5 GMM) Capability information element during a UE Registration procedure. In general, the UDM may determine whether the UE supports secure policy provisioning procedure and inform H-PCF about it.

Alternatively, to the above the H-PCF may request protection of policy information directly from the AUSF. In that scenario the H-PCF requests from UDM the address of AUSF holding the last KAUSF and whether the UE supports secure policy provisioning procedure. The H-PCF requests protection of the policy information from AUSF directly (i.e., similar to steps performed by UDM below).

Behavior on the Udm/ausf:

The behavior on the UDM/AUSF may include the following:
1. UDM receives from H-PCF a request for Policy information protection including the UE Policy information and request for UE secure ack
2. The UDM determines that the UE supports secure policy provisioning (e.g., send back a secure ack) and locate the AUSF that holds the last KAUSF.
3. The UDM sends a request message to the AUSF for Policy information protection including the UE Policy information and indication that a UE secure ack is requested. The AUSF computes a P-MAC-N for the received Policy information using current KAUSF and a PPC stored in the AUSF. The AUSF computes X-P-MAC-UE (e.g., pair thereof) using PPC and indication (e.g., resp. success, failure) of policy update.
3. The UDM receives a response from AUSF including a P-MAC-N, a PPC and X-P-MAC-UE.
4. The UDM sends a response to H-PCF including a P-MAC-N, a PPC and X-P-MAC-UE.

### Detailed Procedure to Secure Ue Policy Information Provisioning

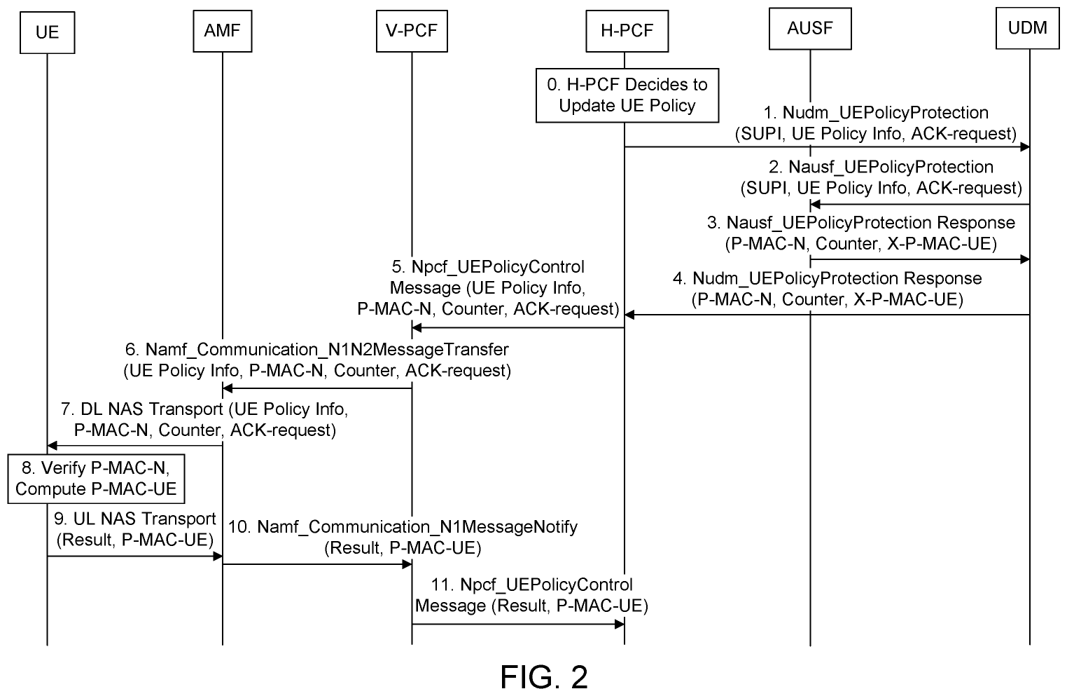

The exemplary FIG. 2 illustrates a signal diagram procedure for Secure Provisioning of UE Policy. This procedure may be triggered during a UE Policy Association establishment or Modification procedure. The events and message indications of the FIG. 2 signal diagram may be described as follows.

FIG. 2 Event 0: The H-PCF decides to update the UE Policy. This may be triggered when receiving a policy association request message from the V-PCF or any trigger for UE policy delivery.

FIG. 2 Message 1: The H-PCF sends to the UDM a request for Policy information protection including the subscription permanent identifier (SUPI), UE Policy information and indication for UE ack requested. The UDM locates UE information and determines that the UE supports secure policy provisioning (e.g., based on configuration, registered capabilities) and locates the AUSF that holds the last KAUSF.

FIG. 2 Message 2: The UDM sends a request message to the AUSF for Policy information protection including the SUPI, UE Policy information and indication that a UE secure ack is requested. The AUSF computes a P-MAC-N using the received Policy information, current KAUSF and a PPC (Counter) stored in the AUSF. The PPC may be stored and initialized to a predetermined initial value at both the UE and AUSF whenever a new KAUSF is established between the AUSF and the UE. The PPC is incremented by AUSF/UE every time a new UE Policy information protection related operation is performed (e.g., generation or successful check of P-MAC-N). If the PPC is about to wrap around, AUSF pauses the Policy protection service and only resumes when a new KAUSF is generated. The H-PCF is informed by UDM/AUSF that the Policy protection service is paused and may be notified by AUSF/UDM when it resumes.

FIG. 2 Message 3: The UDM receives a response from AUSF including a P-MAC-N, the PPC and X-P-MAC-UE.

FIG. 2 Message 4: The UDM forwards the parameters from AUSF to H-PCF. H-PCF stores X-P-MAC-UE along the UE Policy information.

FIG. 2 Message 5: The H-PCF sends to V-PCF a message including the UE Policy information, P-MAC-N, the PPC and indication that a UE secure ack is requested. If V-PCF decides to split the UE Policy information into multiple smaller parts/fragments, V-PCF sends each fragment to AMF separately. In that case, the steps 6 to 10 may be repeated as many times as necessary to transfer the complete UE Policy information.

FIG. 2 Message 6: The V-PCF sends a message to UE via AMF including the UE Policy information (e.g., one of multiple UE Policy fragments), P-MAC-N, the PPC and indication for UE secure ack requested. In the case of UE Policy information split into multiple smaller fragments/parts, the V-PCF includes these parameters along the fragments (e.g., along initial or last fragment). Furthermore, to assist UE in reconstruction of the final UE Policy information, the V-PCF may indicate the number of fragments to expect along the fragments (e.g., along initial fragment).

FIG. 2 Message 7: The AMF forwards the secure UE policy provisioning parameters from V-PCF to UE.

FIG. 2 Event 8: The UE determines that secure UE policy provisioning is required based on UE configuration, the presence of security parameters (e.g., P-MAC-N, PPC). The UE checks that received PPC is greater than stored PPC. The UE stores the security parameters and Policy information (e.g., temporarily store). The UE may receive several fragments individually. In that case, when all necessary UE Policy fragments have been received, the UE combines/re-assembles these fragments into a complete UE Policy information before performing the security verification and update of its UE Policy. When the UE has a complete UE Policy information (e.g., re-assembled all UE Policy fragments/parts together), the UE calculates a MAC using the complete UE Policy information, the current KAUSF and the received PPC. The UE verifies that the calculated MAC matches the received P-MAC-N. If a secure ack was requested the UE computes a secure ack using an indication of reception, current KAUSF and PPC. If the verification is successful, the UE updates its current UE policy using the newly received/reconstructed UE Policy information and update PPC with received PPC value.

FIG. 2 Message 9: The UE sends to AMF a response message to AMF including UE Policy update result and P-MAC-UE if the complete UE Policy was processed. If other fragments are to be expected to UE sends an indication that more UE Policy information part(s) are expected.

FIG. 2 Message 10: The AMF forwards the result from UE to V-PCF. If there are other UE Policy fragments to be sent the V-PCF proceeds with next UE Policy fragment as described in Message 6.

FIG. 2 Message 11: The V-PCF receives a message including the final result, including P-MAC-UE and forwards it to H-PCF. The H-PCF compares the received P-MAC-UE with stored X-P-MAC-UE. If the P-MAC-UE verification is successful, the H-PCF further processes the UE policy update result otherwise if considers that the UE Policy update has failed.

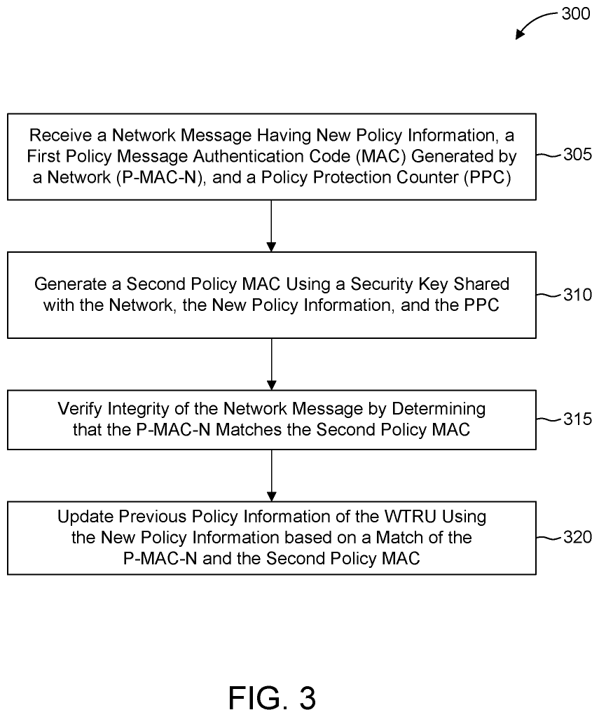

FIG. 3 is an example method 300 performed by a WTRU/UE to conduct a procedure for Secure Provisioning of a WTRU/UE Policy. As in FIG. 2, this procedure may be triggered during a WTRU/UE Policy Association establishment or Modification procedure. In FIG. 3, at 305, the WTRU receives a network message comprising new policy information, a first policy message authentication code (MAC) generated by a network (P-MAC-N), and a policy protection counter (PPC). At 310, the WTRU generates a second policy MAC using a security key shared with the network, the new policy information, and the PPC. At 315, the WTRU verifies the integrity of the network message by determining that the P-MAC-N matches the second policy MAC. At 320, the WTRU updates previous policy information of the WTRU using the new policy information based on a match of the P-MAC-N and the second policy MAC. The updating occurs after the integrity verification indicates a valid network message was received that contained the new policy information.

In one example situation involving the WTRU method of FIG. 3, the new policy information may be transmitted to the WTRU in multiple parts. In that instance, the integrity verification of the network message occurs after re-assembling the new policy information using the multiple received parts. In an example situation, the verification of the network message further includes checking that the PPC is greater than a PPC previously stored by the WTRU.

In one example situation involving the WTRU method of FIG. 3, receiving a network message further includes receiving a request to acknowledge reception of the new policy information. In one example of WTRU operation, the method of FIG. 3 may further include the WTRU sending an acknowledgement message to the network based on successful verification of the network message. In that instance, the WTRU acknowledgement message may include a third policy MAC (P-MAC-UE) generated by the WTRU to send to the network. In that instance, the P-MAC-UE is generated by the WTRU using an indication of successful reception of the new policy information, the security key shared with the network, and the PPC. In one aspect, the PPC limits the number of attempts to introduce the new policy information in the WTRU

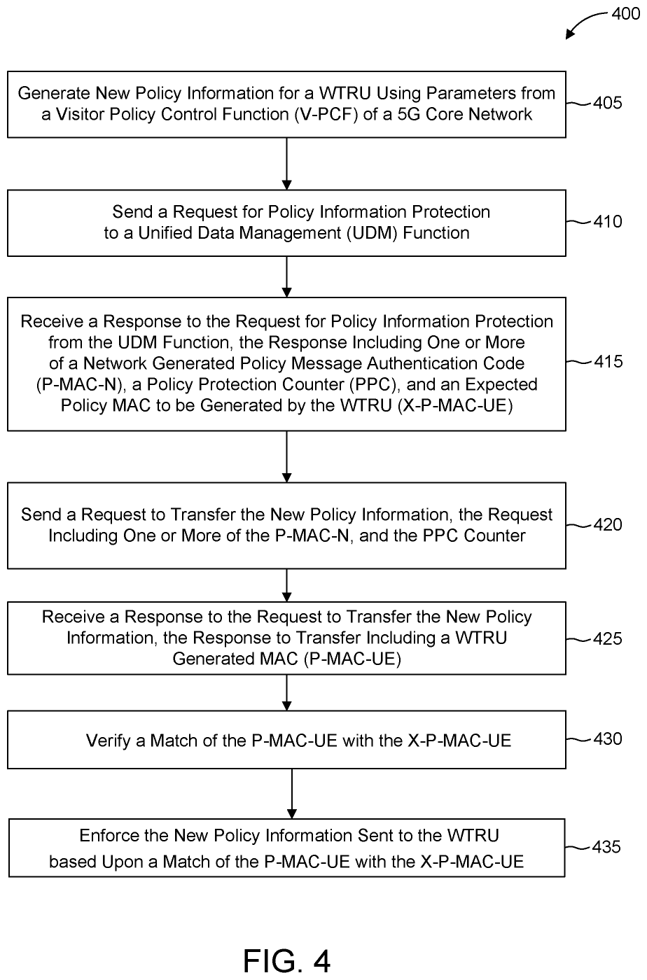

FIG. 4 is an example method 400 performed by a network node in a 5G core network to conduct a procedure for Secure Provisioning of a Policy for a WTRU operating in the network. In one example, the network node may be a home policy control function (H-PCF).

In FIG. 4 at 405, the network node generates new policy information for a WTRU using parameters from a visiting policy control function (V-PCF) of the 5G core network. At 410, the network node sends a request for policy information protection to a unified data management (UDM) function.

At 415, the network node receives a response to the request for policy information protection from the UDM function. The response includes one or more of a network generated policy message authentication code (P-MAC-N), a policy protection counter (PPC), and an expected policy MAC to be generated by the WTRU (X-P-MAC-UE). At 420, the network node sends a request to transfer the new policy information to the V-PCF. The request to transfer the new policy information includes one or more of the P-MAC-N, and the PPC counter.

At 425, the network node receives a response to the request to transfer the new policy information, the response to transfer includes a WTRU generated MAC (P-MAC-UE). At 430, the network node verifies a match of the P-MAC-UE with the X-P-MAC-UE. Upon a successful match, the network node may then be able to enforce the new policy information sent to the WTRU based on the match of the P-MAC-UE with the X-P-MAC-UE.

In one example, the network node at 410 generates the request for policy information protection. The request at 410 may include one or more of the new policy information and an indication of a WTRU acknowledgement request. In one example, at 420, the network node may request to transfer the new policy information where request to transfer includes the indication of the WTRU acknowledgement request.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maint'Ined are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a s“ecific number of an introduced”laim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶16 or means-plus-function claim format, and any claim without the terms “means for” is not so intended.

1. A wireless transmit/receive unit (WTRU) comprising circuitry configured to:
a transceiver; and
a processor operatively coupled to the receiver; wherein:
the transceiver is configured to receive a network message comprising new policy information, a first policy message authentication code (MAC) generated by a network (P-MAC-N), and a policy protection counter (PPC);
the processor is configured to generate a second policy MAC using a security key shared with the network, the new policy information, and the PPC;
the processor and the transceiver are configured to verify integrity of the network message by determining that the P-MAC-N matches the second policy MAC; and
the processor and the transceiver are configured to update previous policy information of the WTRU using the new policy information based on a match of the P-MAC-N and the second policy MAC.

2. The WTRU of claim 1, wherein the WTRU verifies the integrity of the network message after re-assembling the new policy information in an instance when the new policy information is received in multiple parts.

3. The WTRU of claim 1, wherein the processor and the transceiver are further configured to verify integrity of the new policy information by checking that the PPC is greater than a PPC previously stored by the WTRU.

4. The WTRU of claim 1, wherein the network message includes a request to acknowledge reception of the new policy information.

5. The WTRU of claim 1, wherein the processor and the transceiver are further configured to send an acknowledgement message to the network based on successful verification of the network message comprising the new policy information.

6. The WTRU of claim 5, wherein the acknowledgement message includes a third policy MAC (P-MAC-UE) generated by the WTRU to send to the network.

7. The WTRU of claim 6, wherein the P-MAC-UE is generated by the processor using an indication of successful reception of the new policy information, the security key shared with the network, and the PPC.

8. A method performed by a wireless transmit/receive unit (WTRU), the method comprising:
receiving a network message comprising new policy information, a first policy message authentication code (MAC) generated by a network (P-MAC-N), and a policy protection counter (PPC);
generating a second policy MAC using a security key shared with the network, the new policy information, and the PPC;
verifying integrity of the network message by determining that the P-MAC-N matches the second policy MAC; and
updating previous policy information of the WTRU using the new policy information based on a match of the P-MAC-N and the second policy MAC.

9. The method of claim 8, wherein verifying the integrity of the network message occurs after re-assembling the new policy information in an instance when the new policy information is received in multiple parts.

10. The method of claim 8, wherein verifying the integrity of the network message further comprises checking that the PPC is greater than a PPC previously stored by the WTRU.

11. The method of claim 8, wherein receiving a network message further comprises receiving a request to acknowledge reception of the new policy information.

12. The method of claim 8, wherein the method further comprises sending an acknowledgement message to the network based on successful verification of the network message.

13. The method of claim 12, wherein the acknowledgement message includes a third policy MAC (P-MAC-UE) generated by the WTRU to send to the network.

14. The method of claim 13, wherein the P-MAC-UE is generated by the WTRU using an indication of successful reception of the new policy information, the security key shared with the network, and the PPC.

15. The method of claim 14, wherein, wherein the PPC limits the number of attempts to introduce the new policy information in the WTRU.

16. A network node comprising circuitry, the network node configured to:
a transceiver; and
a processor operatively coupled to the transceiver; wherein:
the processor is configured to generate new policy information for a wireless transmit/receive unit (WTRU) using parameters from a visiting policy control function (V-PCF) of a 5G core network;
the transceiver and the processor are configured to send a request for policy information protection to a unified data management (UDM) function;
the transceiver is configured to receive a response to the request for policy information protection from the UDM function, the response including one or more of a network generated policy message authentication code (P-MAC-N), a policy protection counter (PPC), and an expected policy MAC to be generated by the WTRU (X-P-MAC-UE);
the transceiver and the processor are configured to send a request to transfer the new policy information, the request including one or more of the P-MAC-N, and the PPC counter;
the transceiver is configured to receive a response to the request to transfer the new policy information, the response to transfer including a WTRU generated MAC (P-MAC-UE);
the transceiver and the processor are configured to verify a match of the P-MAC-UE with the X-P-MAC-UE; and
the transceiver and the processor are configured to enforce the new policy information sent to the WTRU based upon a match of the P-MAC-UE with the X-P-MAC-UE.

17. The network node of claim 16, wherein the request for policy information protection includes one or more of the new policy information and an indication of a WTRU acknowledgement request.

18. The network node of claim 17, wherein the request to transfer the new policy information includes the indication of the WTRU acknowledgement request.

19. The network node of claim 17, wherein the network node includes comprises a home policy control function (H-PCF).
